(19) United States
(12) Patent Application Publication
(10) Pub. No.: US 2003/0115259 A1
(43) Pub. Date: Jun. 19, 2003

(54) System and method using legacy servers in reliable server pools

(75) Inventor: Ram Gopal Lakshmi Narayanan, Woburn, MA (US)

Correspondence Address: BANNER & WITCOFF, 1001 G STREET N W, SUITE 1100, WASHINGTON, DC, 20001, US

(73) Assignee: Nokia Corporation, ESPOO (FI)

(21) Appl. No.: 10/024,441

(22) Filed: Dec. 18, 2001

(51) Int. Cl. G06F 15/16

(52) U.S. Cl. 709/203

(57) ABSTRACT

A system and method are disclosed for load-sharing in reliable server pools which provide access to legacy servers. A proxy pool element provides an interface between a name server and a legacy server pool, the proxy pool element monitoring legacy application status to effect load sharing and to provide access for an application client via the name server and aggregate server access protocol.

### FIELD OF THE INVENTION

This invention relates to network server pooling and, in particular, to a method for including legacy servers in reliable server pools.

### BACKGROUND OF THE INVENTION

Individual Internet users have come to expect that information and communication services are continuously available for personal access. In addition, most commercial Internet users depend upon having Internet connectivity all day, every day of the week, all year long. To provide this level of reliable service, component and system providers have developed many proprietary solutions and operating-system-dependent solutions intended to provide servers of high reliability and constant availability.

When an application server does fail, or otherwise becomes unavailable, the task of switching to another server to continue providing the application service is often handled by accessing the user's browser. Such a manual switching reconfiguration can be a cumbersome operation. As may often occur during an Internet session, the browser will not have the capability to switch servers and will merely return an error message such as ‘Server Not Responding.’ Even if the browser does have the capability to access a replacement server, there is typically no consideration given to load sharing among the application servers.

The present state of the art has defined an improved architecture in which a collection of application servers providing the same functionality are grouped into a reliable server pool (RSerPool) to provide a high degree of redundancy. Each server pool is identifiable in the operational scope of the system architecture by a unique pool handle or name. A user or client wishing to access the reliable server pool will be able to use any of the pool servers by following server pool policy procedures.

Requirements for highly available services also place similar high reliability requirements upon the transport layer protocol beneath RSerPool; that is, that the protocol provide strong survivability in the face of network component failures. RSerPool standardization has developed an architecture and protocols for the management and operation of server pools supporting highly reliable applications, and for client access mechanisms to a server pool.

However, a shortcoming of RSerPool standardization is the incompatibility of the RSerPool network with legacy servers. A typical legacy server does not operate in conformance with aggregate server access protocol (ASAP) used by RSerPool servers and cannot be registered with an RSerPool system. This poses a problem as many field-tested, stand-alone and distributed applications currently enjoying extensive usage, such as financial applications and telecom applications, are resident in legacy servers. Because of the incompatibility problem, legacy applications are not able to benefit from the advantages of RSerPool standardization.

What is needed is a system and method for load-sharing in reliable server pools which also provide access to legacy servers.

### SUMMARY OF THE INVENTION

In a preferred embodiment, the present invention provides a system and method for load-sharing in reliable server pools which provide access to legacy servers. A proxy pool element provides an interface between a name server and a legacy server pool, the proxy pool element monitoring legacy application status to effect load sharing and to provide access for an application client via the name server and aggregate server access protocol.

### BRIEF DESCRIPTION OF THE DRAWINGS

The invention description below refers to the accompanying drawings, of which:

FIG. 1 illustrates a functional block diagram of a conventional reliable server pool system which does not include a legacy server;

FIG. 2 illustrates a functional block diagram of a reliable server pool system including legacy servers;

FIG. 3 illustrates a flow diagram showing the steps taken by a server daemon and a proxy pool element of FIG. 2 in accessing, polling, and registering a legacy application;

FIG. 4 illustrates a block diagram of the functional components of the legacy servers of FIG. 2; and

FIG. 5 illustrates a flow diagram showing the process of a client accessing a legacy application in the server pool system of FIG. 2.

### DETAILED DESCRIPTION OF THE INVENTION

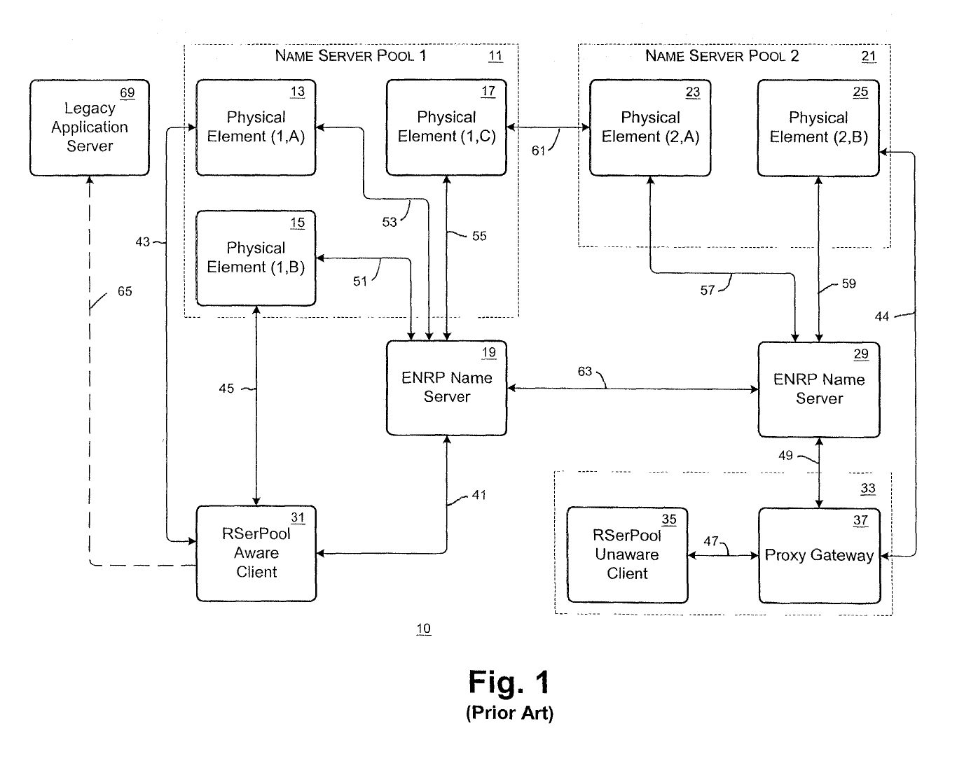

There is shown in FIG. 1 a simplified diagram of a reliable server pool (RSerPool) network 10. As understood by one skilled in the relevant art, features required for the reliable server pool network 10 are provided by means of two protocols: Endpoint Name Resolution Protocol (ENRP) and Aggregate Server Access Protocol (ASAP). ENRP is designed to provide a fully-distributed fault-tolerant real-time translation service that maps a name to a set of transport addresses pointing to a specific group of networked communication endpoints registered under that name. ENRP employs a client-server model wherein an ENRP server responds to name translation service requests from endpoint clients running on either the same host or different hosts.

The reliable server pool network 10 includes a first name server pool 11 and a second name server pool 21. The first name server pool 11 includes RSerPool physical elements 13, 15, and 17 which are server entities registered to the first name server pool 11. Likewise, the second name server pool 21 includes RSerPool physical elements 23 and 25 which are server entities registered to the second name server pool 21. The first name server pool 11 is accessible by an RSerPool-aware client 31, which is a client functioning in accordance with ASAP and is thus cognizant of the application services provided by the first name server pool 11.

As further understood by one skilled in the relevant art, ASAP provides a user interface for name-to-address translation, load sharing management, and fault management, and functions in conjunction with ENRP to provide a fault tolerant data transfer mechanism over IP networks. In addition, ASAP uses a name-based addressing model which isolates a logical communication endpoint from its IP address. This feature serves to eliminate any binding between a communication endpoint and its physical IP address. With ASAP, each logical communication destination is defined as a name server pool, providing full transparent support for server-pooling and load sharing. ASAP also allows dynamic system scalability wherein member server entities can be added to or removed from name server pools 11 and 21 as desired without interrupting service to RSerPool-aware client 31.

RSerPool physical elements 13-15 and 23-25 may use ASAP for registration or de-registration and for exchanging other auxiliary information with ENRP name servers 19 and 29. ENRP name servers 19 and 29 may also use ASAP to monitor the operational status of each physical element in name server pools 11 and 21. These monitoring transactions are performed over data links 51-59. During normal operation, RSerPool-aware client 31 can use ASAP over a data link 41 to request ENRP name server 19 to retrieve the name used by name server pool 11 from a name-to-address translation service. RSerPool-aware client 31 can subsequently send user messages addressed to the first name server pool 11, where the first name server pool 11 is identifiable using the retrieved name as the unique pool handle.

A file transfer can be initiated in the configuration shown by an application in RSerPool-aware client 31 by submitting a login request to the first name server pool 11 using the retrieved pool handle. An ASAP layer in RSerPool-aware client 31 may subsequently send an ASAP request to first name server 19 to request a list of physical elements. In response, first name server 19 returns a list of RSerPool physical elements 13, 15, and 17 to the ASAP layer in RSerPool-aware client 31 via data link 41. The ASAP layer in RSerPool-aware client 31 selects one of the physical elements, such as RSerPool physical element 15, and transmits the login request. File transfer protocol (FTP) control data initiates the requested file transfer to RSerPool physical element 15 using a data link 45.

If, during the above-described file transfer conversation, RSerPool physical element 15 fails, a fail-over is initiated to another pool element sharing a state of file transfer, such as the RSerPool physical element 13. The RSerPool physical element 13 continues the file transfer via a data link 43 until the transfer requested by RSerPool-aware client 31 has been completed. In addition, a request is made from RSerPool physical element 13 to ENRP name server 19 to request an update for first name server pool 11. A report is made stating that RSerPool physical element 15 has failed. Accordingly, RSerPool physical element 15 can be removed from the first name server pool listing in a subsequent audit if ENRP name server 19 has not already detected the failure of RSerPool physical element 15.

Using a similar procedure, a file transfer can be initiated by an application in an RSerPool-unaware client 35. Such a file transfer is accomplished by submitting a login request from RSerPool-unaware client 35 to a proxy gateway 37 using transmission control protocol (TCP) via a data link 47. Proxy gateway 37 acts on behalf of RSerPool-unaware client 35 and translates the login request into an RSerPool-aware dialect. An ASAP layer in proxy gateway 35 sends an ASAP request to a second ENRP name server 29 via a data link 49 to request a list of physical elements in second name server pool 21. In response, ENRP name server 29 returns a list of the RSerPool physical elements 23 and 25 to the ASAP layer in proxy gateway 37.

ASAP layer in the proxy gateway 37 selects one of the physical elements, for example RSerPool physical element 25, and transmits the login request to RSerPool physical element 25 via the data link 59. File transfer protocol control data initiates the requested file transfer. As can be appreciated by one skilled in the relevant art, RSerPool-unaware client 35 is typically a legacy client which supports an application protocol not supported by ENRP name server 29. Proxy gateway 37 acts as a relay between ENRP name server 29 and RSerPool-unaware client 35 enabling the combination of RSerPool-unaware client 35 and proxy gateway 37, functioning as an RSerPool client 33, to communicate with second name server pool 21.

ASAP can be used to exchange auxiliary information between RSerPool-aware client 31 and RSerPool physical element 15 via data link 45, or between RSerPool client 33 and RSerPool physical element 25 via data link 44, before commencing in data transfer. The protocols also allow for RSerPool physical element 17 in the first name server pool 11 to function as an RSerPool client with respect to second name server pool 21 when RSerPool physical element 17 initiates communication with RSerPool physical element 23 in second name server pool 21 via a data link 61. Additionally, a data link 63 can be used to fulfill various name space operation, administration, and maintenance (OAM) functions. However, the above-described protocols do not accommodate reliable server pool network 10 fulfilling a request to provide RSerPool-aware client 31 (or RSerPool client 33) access to non-RSerPool servers, a request failure being represented by dashed line 65 extending to a legacy application server 69. Accordingly, reliable server pool network 10 comprises only RSerPool physical elements and does not include legacy application servers.

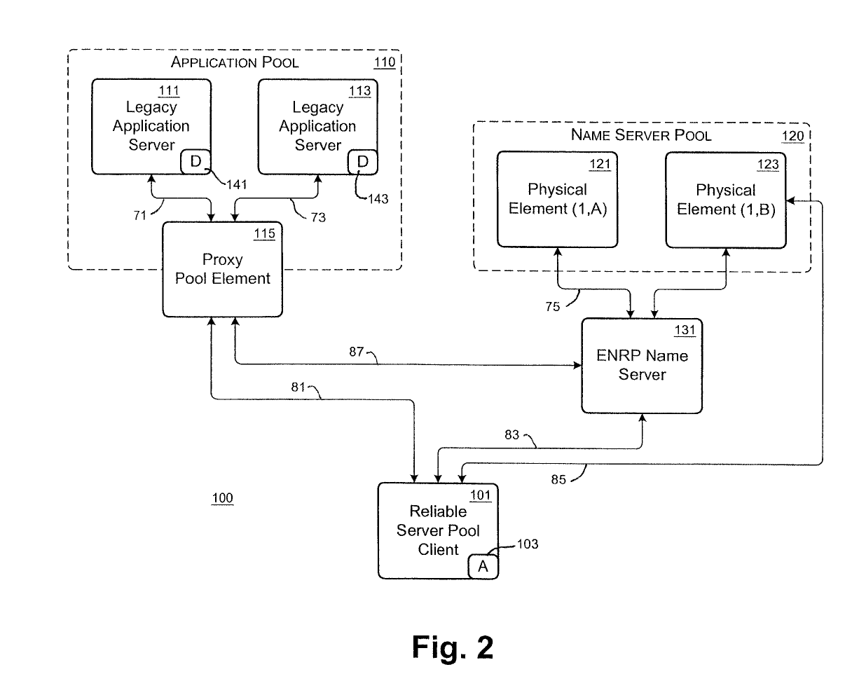

There is shown in FIG. 2 a server pool network 100 which provides a reliable server pool client 101 access to legacy servers 111 and 113 resident in an application pool 110, as well as access to RSerPool physical elements 121 and 123 resident in a name server pool 120. Reliable server pool client 101 may comprise RSerPool-aware client 31 or RSerPool client 33, for example, as described above. Application status in legacy server 111 is provided to a proxy pool element 115 by a daemon 141. Likewise, application status in the legacy server 113 is provided to the proxy pool element 115 by a daemon 143. Operation of daemons 141 and 143 is described in greater detail below.

An application 103 in the reliable server pool client 101 can initiate a file transfer from RSerPool physical element 123, for example, by submitting a login request to an ENRP name server 131 using the appropriate pool handle. An ASAP layer in reliable server pool client 101 subsequently sends an ASAP request to ENRP name server 131, and ENRP name server 131 returns a list, which includes RSerPool physical element 123, to the ASAP layer in reliable server pool client 101 via a data link 83.

File transfer from RSerPool physical element 123 to reliable server pool client 101 is accomplished via a data link 85.

Application 103 can also initiate a file transfer from legacy application server 111, for example, by submitting a login request to ENRP name server 131 using an application pool handle. Proxy pool element 115 acts on behalf of legacy servers 111 and 113 by interfacing between ENRP name server 131 and legacy servers 111 and 113 so as to provide reliable server pool client 101 with access to an application in application pool 110. Proxy pool element 115 is a logical communication destination defined as a legacy server pool and thus serves as an endpoint client in server pool network 100.

Accordingly, the ASAP layer in reliable server pool client 101 sends an ASAP request to ENRP name server 131, which communicates with an ASAP layer in proxy pool element 115. Proxy pool element 115 returns a list, which includes legacy application server 111, to ENRP name server 131 for transmittal to the ASAP layer in reliable server pool client 101 via data link 83. File transfer from legacy application server 111 to reliable server pool client 101 is accomplished via a data link 81.

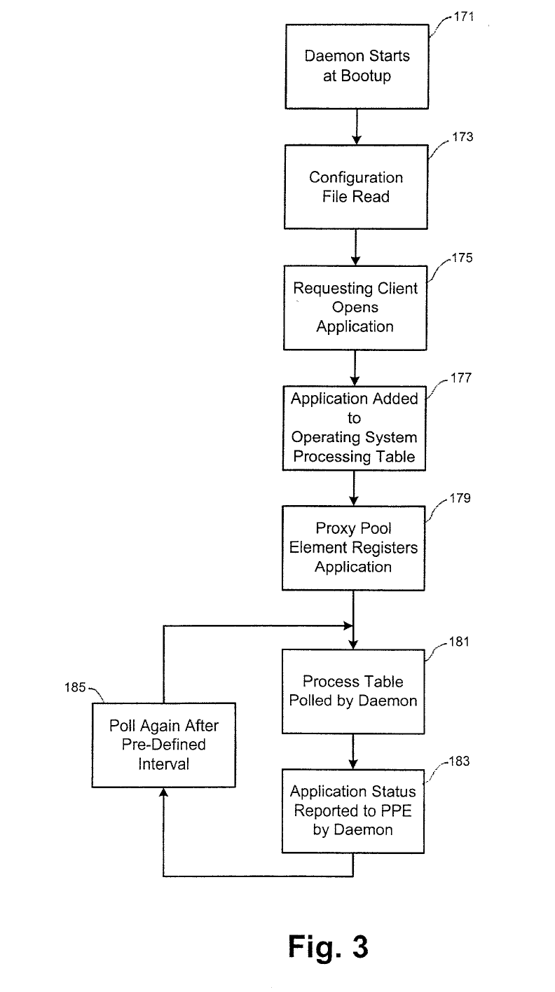

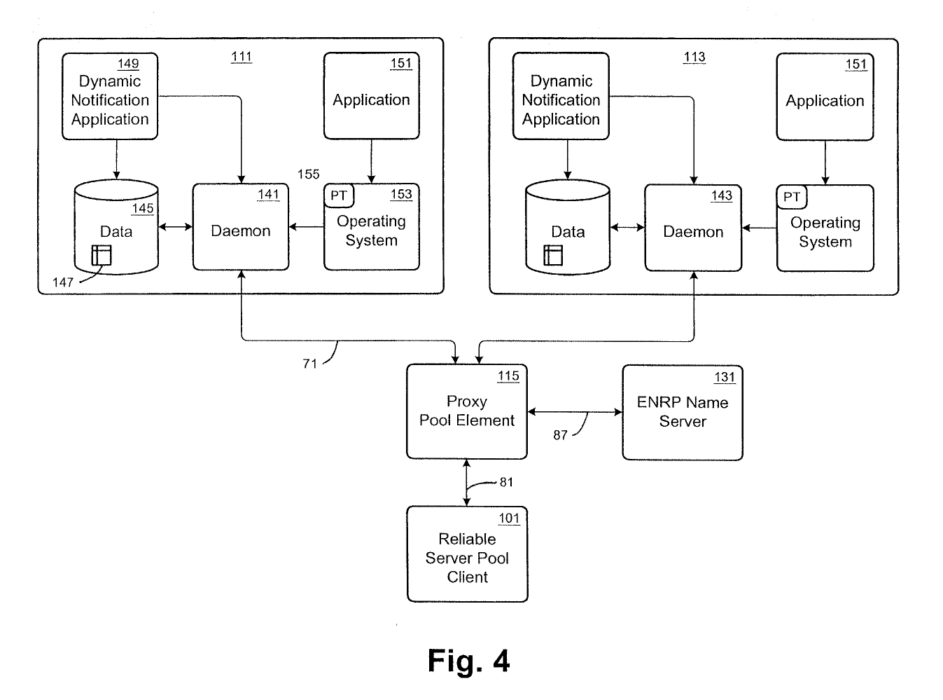

The list returned to reliable server pool client 101 by ENRP name server 131 is generated by proxy pool element 115. Proxy pool element 115 communicates with daemons 141 and 143, as described in the flow chart of FIG. 3, to establish the status of the legacy servers and applications resident in application pool 110. Daemon 141, shown in greater detail in FIG. 4, starts as part of the boot up process for legacy server 111, at step 171. Daemon 141 also reads a configuration file 147 in a configuration database 145, at step 173. Reliable server pool client 101 starts an application 151 in legacy server 111, at step 175, and application 151 is added to a process table 155 in an operating system 153 resident in legacy server 111, at step 177. It should be understood that the application 151 may be a stand-alone application or a distributed application.

Proxy pool element 115 performs registration of application 151, at step 179. At this time, proxy pool element 115 may also register any other applications (not shown) running in application pool 110. The registration processes are performed between proxy pool element 115 and respective application servers 111 and 113. Daemon 141 polls process table 155 to establish the status of the applications, including application 151, at step 181. The status of the application(s) is then provided to proxy pool element 115 by daemon 141, at step 183. The pooling of servers, performed during the registration procedure, establishes a pooling configuration used for load balancing. The pooling configuration includes a list of servers providing a particular application and server selection criteria for determining the method by which the next server assignment may be made. Criteria for the selection of a server in a particular server pool are based on policies established by the administrative entity for the respective server pool.

A typical pooling configuration may have the following entries:

Application ‘A’

IP1 is running

IP2 is running

IP3 is running

Round-robin Priority

Application ‘B’

IP1 is running

IP3 is running

IP4 is not running

FIFO Priority

In the above examples, servers for Application ‘A’ are selected in a round-robin process, in accordance with an administrative policy. That is, IP2 is assigned after IP1 has been assigned, IP3 is assigned after IP2 has been assigned, and IP1 is assigned after IP3 has been assigned. On the other hand, servers for Application ‘B’ are assigned using a first-in, first-out process in accordance with another administrative policy. It can be appreciated by one skilled in the relevant art that pool prioritization criteria can be specified without restriction if the criteria otherwise comply with applicable administrative policy. Other pool prioritization criteria are possible. For example, server selection can be made on the basis of transaction count, load availability, or the number of applications a server may be running concurrently.

As application 151 is made available to reliable server pool client 101, daemon 141 continues to periodically poll process table 155 for subsequent changes to the status of application 151, at step 185. If the entry in configuration file 147 is modified by action of the reliable server pool client 101 or other event, a dynamic notification application 149 may send revised configuration file 147 to daemon 141. Similarly, if application 151 fails, daemon 141 may be notified via the polling process. As daemon 141 reads configuration file 147, the information resident in proxy pool element 115 may be updated as necessary.

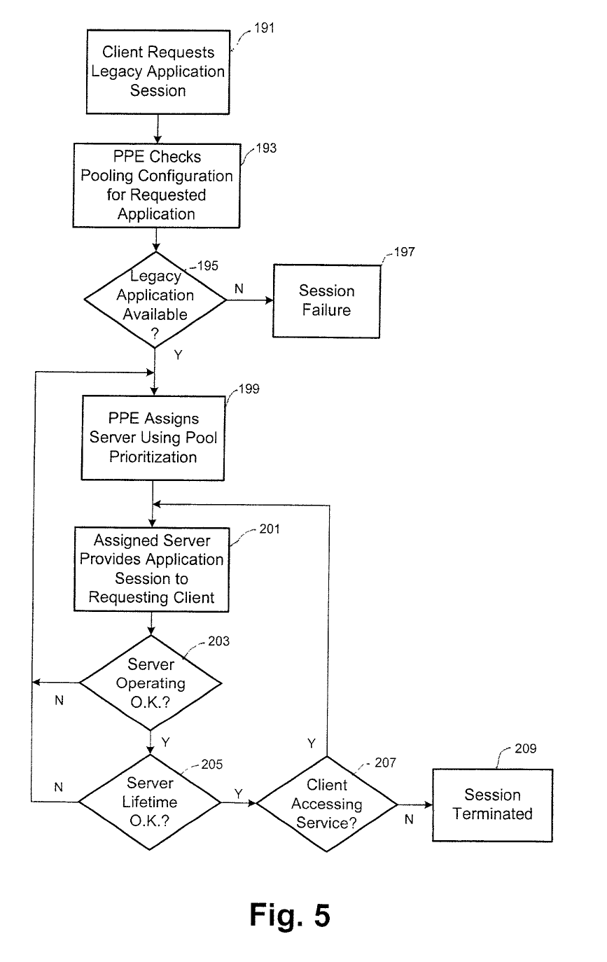

Operation of proxy pool element 115 can be described with additional reference to the flow diagram of FIG. 5 in which reliable server pool client 101 has submitted a request for a legacy application 151 session, at step 191. Proxy pool element 115 checks the pooling configuration for servers available to provide the requested application, at step 193. If the polling reports from daemons 141 and 143 indicate that application 151 is not available, the session fails, at step 197.

If the requested application 151 is available, proxy pool element 115 identifies the servers providing the requested application and, in accordance with one or more pre-established, pool-prioritization, load-balancing criteria, selects one of the identified servers to provide the requested service, at step 199. For example, in response to a request for Application ‘A’ above, a proxy pool element 115 would identify servers IP1 and IP2 as available servers capable of providing the requested service. Using the round-robin pool prioritization process specified for Application ‘A,’ server IP2 would be selected if server IP1 had been designated in the immediately preceding request for Application ‘A.’

The selected legacy server continues to provide application service 151 to reliable server pool client 101 until any of three events occurs. First, if the selected server fails to operate properly, at decision block 203, operation returns to step 199 where proxy pool element 115 selects another, functioning server to provide the requested application, in accordance with the pool prioritization procedure. Secondly, if the lifetime of the selected server has expired, operation also returns to step 199. The lifetime of the server may be related to the server work cycle and may take into account scheduled server shutdowns for routine maintenance. Third, at decision block 207, reliable server pool client 101 can terminate application 151 session, at step 209.

While the invention has been described with reference to particular embodiments, it will be understood that the present invention is by no means limited to the particular constructions and methods herein disclosed and/or shown in the drawings, but also comprises any modifications or equivalents within the scope of the claims.

I/We claim:

1. A method for providing legacy application service to a client, the client operating in conformance with aggregate access server protocol (ASAP), said method comprising the steps of:
requesting access to a legacy application via a proxy pool element;
registering said legacy application with said proxy pool element; and
selecting a legacy server to provide said legacy application to the client.

2. A method as in claim 1 further comprising the step of checking a status of said legacy application in response to said step of requesting access to said legacy application.

3. A method as in claim 2 wherein, in the selecting step, said legacy server comprises a daemon for providing said legacy application status to said proxy pool element.

4. A method as in claim 3 wherein said daemon provides said legacy application status by polling a process table in said legacy server.

5. A method as in claim 1 wherein said proxy pool element comprises an endpoint server operating in conformance with ASAP.

6. A method as in claim 1 wherein said step of selecting a legacy server comprises the step of making a selection based on a pre-established server selection criterion.

7. A method as in claim 6 wherein said pre-established server selection criterion is based on a policy established by a server administrative entity.

8. A method as in claim 6 wherein said pre-established server selection criterion comprises a member of the group consisting of: a round-robin selection, a first-in-first-out selection, transaction count, load availability, and number of concurrently-running applications.

9. A server pool network suitable for providing application services to a client, said server network comprising:
a name server pool including at least one physical element operating in accordance with aggregate server access protocol (ASAP), said physical element for providing an application service;
an application server pool including a proxy pool element and at least one legacy application server, said legacy application server for providing a legacy application service, said proxy pool element having an ASAP layer for communicating with endpoint name resolution protocol (ENRP) components; and
an ENRP server in communication with said name server pool and said proxy pool element, said ENRP server for providing said application service and said legacy application service to the client.

10. A server pool network as in claim 9 wherein said proxy pool element further comprises means for receiving an application status from said at least one legacy application server.

11. A server pool network as in claim 9 wherein said proxy pool element further comprises means for registering a legacy application resident in said at least one legacy application server.

12. A server pool network as in claim 9 wherein said proxy pool element further comprises means for establishing a pooling configuration used for load balancing.

13. A server pool network as in claim 12 wherein said pooling configuration comprises a list of available application servers and a server selection criterion.

14. A server pool network as in claim 9 wherein said legacy application server comprises a daemon for providing an application status to said proxy pool element.

15. A server pool network as in claim 14 wherein said legacy application server further comprises a configuration file and a dynamic notification application for providing said configuration file to said daemon.

16. A server pool network as in claim 14 wherein said legacy application server further comprises a process table for retaining application status, and wherein said daemon includes means for polling said process table.

17. A proxy pool element comprising:
an application server access protocol (ASAP) layer for communicating with endpoint name resolution protocol (ENRP) components; and
means for generating an application server list.

18. A proxy pool element as in claim 17 further comprising means for performing registration and de-registration of a legacy application.
